(19) United States
(12) Patent Application Publication
(10) Pub. No.: US 2023/0314553 A1
(43) Pub. Date: Oct. 5, 2023

(54) Indoor Positioning System and Method

(71) Applicants: Robert A. Diamond, Prosper, TX (US); Jackson T. Diamond, Prosper, TX (US)

(72) Inventors: Robert A. Diamond, Prosper, TX (US); Jackson T. Diamond, Prosper, TX (US)

(21) Appl. No.: 18/165,194

(22) Filed: Feb. 6, 2023

Related U.S. Application Data
(60) Provisional application No. 63/307,026, filed on Feb. 5, 2022.

(51) Int. Cl. G01S 5/02; H04B 17/318; H04W 4/80

(52) U.S. Cl. CPC G01S 5/0284; H04B 17/318; H04W 4/80

(57) ABSTRACT

A system for determining a position of a target in an area of interest includes at least three secondary nodes that are each configured to continuously scan the area of interest and detect a received signal strength to each other and the target. The system also includes a primary node having a positioning module configured to determine a respective circle or sphere for each secondary node using the RSSI as the respective circle or sphere’s radius, and determine respective intersection points or circles caused by an overlap of each two-circle or three-sphere combination for each unique two primary node combination of the primary nodes. The positioning module is configured to determine respective line segments or planes for each set of respective intersection points or circles, and when intersections of the line segments or planes creates a respective triangular or volumetric space, determining a center of the space.

### CROSS-REFERENCE TO RELATED APPLICATIONS

This patent application claims the benefit of U.S. Provisional Pat. Application Serial No. 63/307,026 filed Feb. 5, 2022, which is herein incorporated by reference.

### BACKGROUND

Currently the Global Positioning System (GPS) has dramatically overshadowed all previous methods of global navigation. This has come about largely because of the mandate from the U.S. government in 1999 that required all mobile phone manufacturers to provide location data on incoming 911 calls. The telephony industry identified GPS as the most promising technology to satisfy this mandate. The resulting enormous market demand drove the rapid development of improved GPS chip sets along with dramatic decreases in the price.

The use of GPS for positioning has become so universal that it is natural to assume that GPS technology provides the only solution needed for positioning systems. However, GPS technology relies on satellite communications which, in turn, requires an unobstructed path between the satellites and the receivers interpreting the transmitted data. As a result, GPS technology may become unreliable along obstructed pathways and inside large, enclosed spaces. Ironically, this is of current great consequence in locating the source of many 911 calls. Of at least equal interest are the various commercial purposes for indoor mapping, such as guidance though a museum, a mall, a hospital, a school, or a large office building.

There are some businesses selling indoor mapping solutions today, but the underlying technology is quite varied and there is no universally-embraced solution. The very fact that there is no apparent census on the best way to solve this problem has prompted a creation of a low-cost and low-maintenance solution.

1. GPS - The Global Positioning System was originally created for use by the U.S. military. GPS’ more current widespread civilian use was at first purposely restricted to reduced accuracy in order to prevent foreign threats from using it against the U.S. It is based on 24 satellites in six orbital planes, which are approximately 12,500 miles above the earth’s surface. Each orbiting satellite transmits its position continuously, along with the time of the transmission. Receivers on or near the surface of the earth calculate their position through an analysis known as trilateration. That is, they calculate their position through comparison of distances transmitted simultaneously from multiple satellites. Calculating an absolute distance from each synchronized satellite transmission is possible by measuring the time of travel of the signal from the satellite, knowing that the speed of the signal travel is the speed of light. The calculation is simple but requires high accuracy. Comparing the results from three satellites yields a two-dimensional location usually expressed as latitude and longitude. The use of four or more satellites provides for three-dimensional location.

One cannot use GPS in an enclosed space since the receiver on the ground often cannot receive signals from the satellites. Also, one cannot use fixed transmitters on the ground in place of the satellites, and then use the GPS chips and calculations, as the distances are too close to accurately measure as signal time of travel.

2. Thumb Printing - A current academic favorite for indoor positioning is the idea of installing fixed location radio frequency (RF) transmitters around the indoor space to be monitored, and then creating a detailed map of the received signal strength (RSSI) of those transmitters in one meter intervals in each direction within the space to be monitored. A mobile device within the monitored space transmits its current RSSI values to a host computer, which does a database lookup of the map values and returns a most likely location to such mobile device.

This brute force solution may be acceptable in some applications, but the labor required to install and maintain the solution in any sizable space make it impractical for most commercial interest. In addition, the created map of recorded RSSI values may be easily corruptible through something as simple as rearranging furnishings within the monitored space. This approach seems mostly useful for fulfilling a classroom assignment, with a one-time demonstration in a clean lab environment.

3. Triangulation - At a high level, triangulation is the process of determining the location of a point by measuring only angles to the point from known points, rather than measuring distances to the point directly, as in trilateration. By calculating the direction to a Target from three fixed points whose locations are known, one can determine the location of the Target as the intersection of the three resulting line segments. The calculation is simple and may be very accurate. The challenges with an actual triangulation implementation for indoor positioning system though are numerous. First, determining the required angle measurements from each of the stationary points with useful accuracy may be difficult. To be compact in size and completely automatic, the solution would require purpose-built electronics for the stationary units, each utilizing some type of antenna array. This does not invalidate the approach, but would instead inhibit rapid and widespread adoption for commercial applications. Second, focusing on one Target within the monitored space while hundreds may be simultaneously sensed might prove an additional challenge. In other words, high target density is reasonably and more expected in a confined area than it would be in an outdoor setting.

4. Proximity Sensing - This is likely the most successful and widely adopted type of indoor positioning system being used in commercial applications today. Understanding why requires some background information. A technology marketed as Bluetooth Smart was completed in early 2010. The first smartphone to implement this technology was the iPhone 4S, released in October 2011. A number of other manufacturers then released Bluetooth Low Energy (BLE), which was old in devices in 2012. Proximity sensing is now prominent in virtually all handheld, wearable, and accessory-connectable devices. This carefully written specification has been faithfully adhered to by all equipment providers, which has in turn led to reliable and universal wireless interoperability between all modern mobile devices.

### SUMMARY

BLE was originally focused on sending small packets of information at a low latency, as might be most required in an “Internet Of all Things (IOT)” where the sending unit is monitoring and wirelessly reporting sensor readings for sensed conditions like temperature, pressure, movement or status. The sending units were small in size and could run on a coin-cell battery for months. Then, as now, each sending unit would announce its availability to in-range receiving units through a process referred to as “advertising”. Every smartphone and tablet today has the necessary chip set and firmware to “hear” all BLE advertising that is occurring within about 50 to 100 meters of its physical location.

The robustness of the BLE standard allows it to be applied to many applications. Purpose-built BLE sending units that continuously advertise, but monitor nothing, are the backbone of the Proximity Sensing solution. Such BLE sending units are referred to as “beacons”. In the advertising protocol they each send their own unique identifying name or number. This unique “beacon ID” can be mapped manually in a central database to the physical location within the monitored indoor space where the beacon has been placed. On the receiving side, one can read the received signal strength (RSSI) of each scanned beacon. The RSSI value is an indicator of how distant a beacon is from the receiving unit, but it is a very poor one. The signal strength is affected by many dynamic factors separate from distance. Scholarly attempts to directly convert the RSSI values to accurate linear distances have all failed. As it turns out, this is not a big concern. One can reliably determine when a receiver is “close to” a beacon, as in when it enters or exits a two-to-three meter radius, which is acceptable in a lot of applications.

As an example, consider a shopper in a large department store who has agreed to load a store-provided app on their smartphone. The app continuously scans for beacons and the smartphone reports wirelessly the beacon ID when it gets “close to” one. The store-maintained database may show that a currently sensed near beacon is located under the counter of women’s casual shoes. If the buying history of this customer indicates a potential interest, then the app will display information about those shoes on their smartphone. When the shopper moves away from the particular beacon, the app takes down that information on the phone. The app may also record, track, and anticipate this particular customer’s beacon-to-beacon movement throughout the store.

As another example, a smartphone could show information about a museum exhibit that a user just approached, for instance, or it could show if the user is walking in the right direction to get to a user’s next appointment in a building. By placing beacons over doorways one could provide last known information about personnel movement within a large complex.

Even though Proximity Sensing is reliable and simple, and can be used to address some indoor positioning needs, there are a few disadvantages. Some disadvantages are business considerations related to the equipment and IT development cost of creating a specific implementation, followed by the ongoing maintenance or servicing costs. The “close″/ “not close” paradigm, by definition, often requires a somewhat high density of beacons. The beacons themselves are commonly available and relatively inexpensive but, in some applications, hundreds or thousands of them might be desired. And each unique beacon ID has to be mapped to a physical location for relevance. The mapping has to be kept up to date, as the beacons and their individual references change. In addition, the beacons are typically battery powered. Thus, under adverse conditions, the batteries may only last weeks. Someone, or some team, must continuously monitor for beacons that have ceased to function and then usually change the battery on those failed beacons.

The summary of the invention, according to one embodiment, includes a method of determining a position of a target in an area of interest by continuously scanning the area of interest using three secondary nodes, and detecting, via each secondary node, a received signal strength (RSSI) to the target. The method further includes determining a respective circle for each secondary node using the RSSI as the respective circle’s radius and determining respective intersection points caused by an overlap of each two circle combination for each unique two secondary node combination of the three secondary nodes. Then the method includes determining respective line segments for each set of respective intersection points and, when intersections of the line segments creates a triangular space, determining a center of the triangular space, which is indicative of the position of the target.

The secondary nodes and target may be Bluetooth low energy (BLE) devices, and the method may further include displaying the position of the target on a user interface, or sending the position of the target to the target. The determining steps may be performed by a primary node separate from the secondary nodes. The method may further include receiving, at the primary node, data from the secondary nodes, and determining a set of coordinates for the secondary nodes. The continuous scanning may include scanning at intervals between one and five seconds.

### BRIEF DESCRIPTION OF THE DRAWINGS

Various embodiments of the subject system and method are described herein with reference to the drawings wherein:

FIG. 1A is a plan view of a two-dimensional indoor area according to an embodiment of the present disclosure;

FIG. 1B is a two-dimensional cartesian coordinate schematic of an indoor positioning system and method according to an embodiment of the present disclosure; and

FIGS. 2A and 2B are flowcharts of example software modules for use in an indoor positioning system and method according to an embodiment of the present disclosure.

### DETAILED DESCRIPTION

Embodiments of an indoor positioning system and method described herein may be referred to herein as “Constant Calculation”. Although the present disclosure is written in the context of an indoor positioning system, those skilled in the art will understand that embodiments of the present disclosure may be applicable to an outdoor positioning system as well.

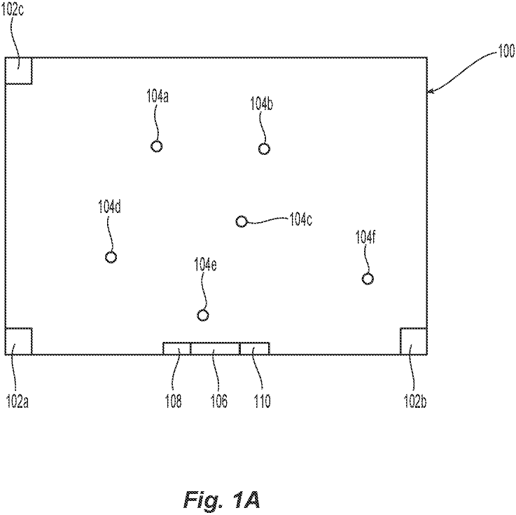

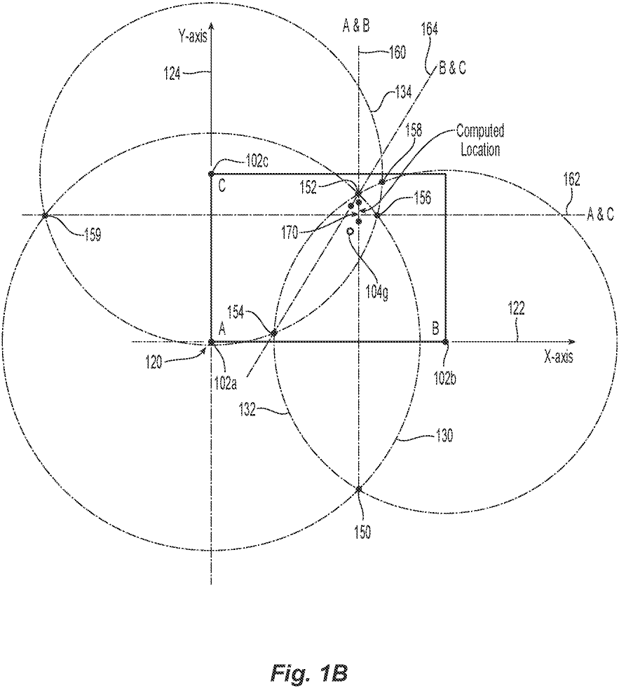

Referring to FIG. 1A, and indoor area 100 is illustrated in two-dimensions for clarity of description. Indoor area 100 may be any suitable single-story indoor area, such as a department store, school, hospital, etc., that includes a plurality of Targets 104a-f. In one embodiment, Targets 104 are BLE devices, such as smartphones or tablets; however, other suitable devices transmitting signals wirelessly are contemplated. All Targets 104 within indoor area 100 are continuously scanned. The term “continuous” in the context of the present disclosure means that the scans occur every few milliseconds, but it is also meant to capture scans that are near continuous such that there is very small intervals (e.g., between one and five seconds) between the scans. Depending on the application, the actual items of interest are typically the users carrying Targets 104 or the assets attached to them. As described in more detail below, a great volume of dynamic real-time information received in the scans is repeatedly analyzed as soon as the received data is available in order to determine the spatial coordinates (i.e., the position) of each Target 104 of interest. In one embodiment, the computation is mathematical and is not based on a detailed data map of indoor area 100 or any last known position strategy. The Constant Calculation methodology described herein has been demonstrated on off-the-shelf devices to ensure that the solution has practical merit. And initial software development demonstrates that the solution is viable.

In one embodiment, Constant Calculation treats the challenges of indoor positioning as a theoretical math problem that avoids creating a solution that addresses a specific set of needs or detailed goals. A motivation for that approach is to create methods and related software that are useful as fundamental building blocks for the creation of a wide variety of indoor positioning commercial products, each of which may require different embodiments of the present disclosure.

Referring to FIG. 1A, and with reference to FIG. 1B, in one embodiment, Targets 104 are smartphones or tablets associated with specific users. Several Targets 104a-f to be monitored may be positioned within indoor area 100 and their position is typically very dynamic because of movement of the users. Indoor area 100 also includes a plurality of secondary nodes (102a, 102b, 102c), referred to herein as “Corners”. From a geometrical and computational viewpoint, the actual corners of indoor area 100 is where Corners 102 are best located; however, other suitable locations are also contemplated by the present disclosure. It is important to have a minimum of three Corners 102 for a two-dimensional computation, and a minimum of four Corners 102 for a three-dimensional computation (e.g., if indoor area 100 has multiple floors). Corners 102 may be spaced apart and arranged in any suitable configuration, and each of the Corners 102 continuously scans indoor area 100 for Targets 104.

Each Target 104a-f transmits a unique identification (ID). All Corners (102a, 102b, 102c) can detect that unique ID, along with their own particular received signal strength (RSSI) to a detected Target 104. The RSSI is one metric for distance between a respective Target 104 and Corner 102, but as described in the background above, it is generally unreliable and of low accuracy. However, an indoor positioning system and method according to an embodiment of the present disclosure is the creation of a system and method to use RSSI in the best way possible in spite of some of its perceived limitations.

Corners 102a-c scan Targets 104a-f using BLE or other suitable wireless technology and condense and repeat the gathered information over Wi-Fi. In most indoor areas 100, Corners 102a-c receive scanned data from multiple Targets 104a-f continuously. By having Corners 102a-c repeat the information scanned, one can include in their data packets the unique IP address of each of them. By having the information sent over Wi-Fi, one can accommodate both a host-based and a client-based computing architecture.

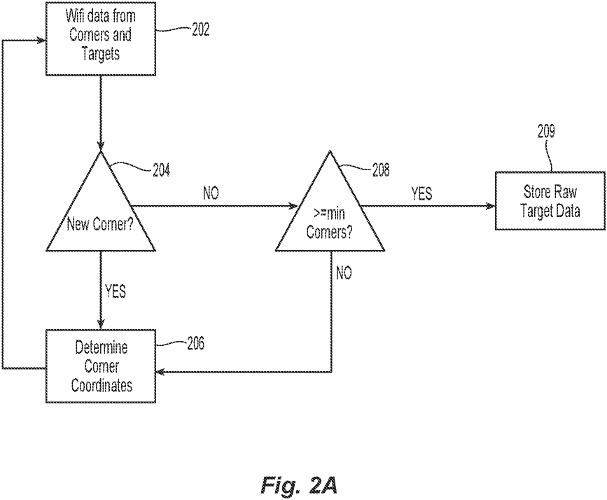

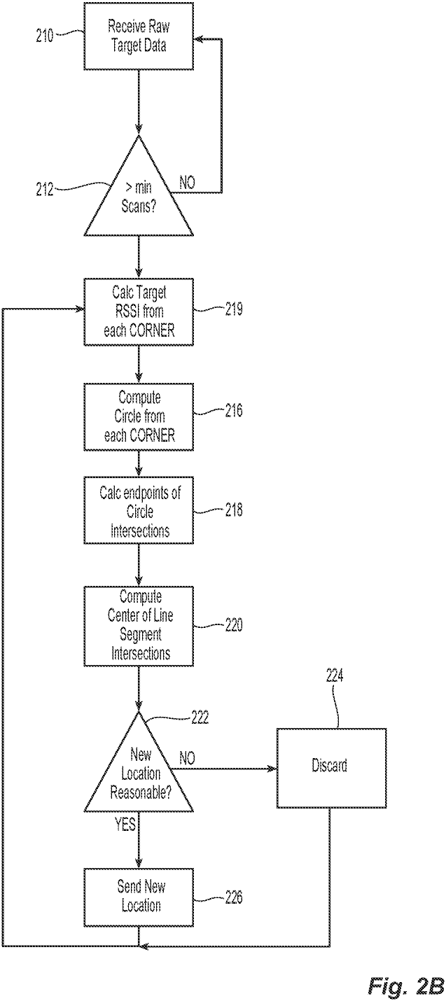

In one embodiment, one or more primary nodes 106 (e.g., a host computer or other suitable controller) receives the information from all Corners 102a-c and reduces this raw data to positioning information on all Targets 104a-f. In one embodiment, a software application 108 associated with primary node 106 utilizes this raw data to create a continuously revised set of spatial coordinates for each of Targets 104a-f. The software application 108 is referred to herein as “IPS_Logic”, an example of which is shown in the flowcharts of FIGS. 2A and 2B, which are described in more detail below. These coordinates are either used by the IPS_Logic program to feed a local mapping and display module 110 in order to provide a suitable presentation in a user interface (e.g. by the user interface of a particular target 104), or they are rebroadcast under another Wi-Fi service for use by other computers and/or applications.

With reference to FIG. 2A, an important feature of Constant Calculation is that Corners 102 not only scan for all available Targets 104, they simultaneously act as a beacon that can identify itself as a Corner. This is seen by all other Corners 102. This allows one to start with known distances between all Corners 102, expressed in RSSI. Each Corner (102a, 102b, or 102c) broadcasts its sensed RSSI distance to all other Corners, as those Corners also report their RSSI distance from it. The IPS_Logic software, a module of which is shown in FIG. 2A, collects and analyzes these values for accuracy during its initialization. As such, in step 202 the RSSI distance data of Corners 102a-c and Targets 104a-f is received at all Corners 102a-c. It is then determined, at step 204 if a new Corner was detected. If a new Corner is detected, then the coordinates of that particular Corner is determined at step 206 and the process is continuously repeated until no new Corners are detected. Then, at step 208, once the minimum number of Corners 102 are met, the raw data for all Corners 102 and Targets 104 are stored (step 209) for use in determining the position data of any of the Targets 104a-f, as described in more detail below in conjunction with FIG. 2B.

With reference to FIG. 1B, one envisions a Cartesian coordinate system with one of the Corners 102a located at the origin 120 and a second Corner (either 102b or 102c) located on either x-axis 122 or y-axis 124, respectively. The positions of any remaining Corners within indoor area 100 are computed following the assignment of these initial two. One important advantage of the Constant Calculation system and method, according to one embodiment, is that it does not care about particular distance data (e.g., feet or inches). The positions of all Targets 104 may be calculated as relative to Corners 102. In some embodiments, there is a final step of providing a real-world reference, depending on the goals of the specific implementation. A simple example is situating the physical location of Corners 102 on a floor plan of monitored indoor area 100, overlaid with the plotted location of Targets 104 in the coordinate system envisioned as shared by Corners 102.

With reference to FIG. 2B and continued reference to FIG. 1B, at step 210, the raw data from step 209 is utilized to determine the actual position of a Target 104g, e.g. First, at step 212, the software module confirms that the minimum amount of data exists to do the calculations. If so, then each Corner 102, from its fixed location, reads the distance to Target 104g as an RSSI value (see step 214 in FIG. 2B). In step 216, these simultaneously reported distances are utilized to calculate the values for a respective circle (130, 132, 134) for the illustrated two-dimensional implementation (or spheres for a three-dimensional implementation) from each Corner 102a, 102b, 102c. Theoretically, these circles all intersect one another at a single point, which is the actual location of Target 104g. Excellent accuracy, however, is often unobtainable when using RSSI. For that reason, in one embodiment of the indoor positioning system of the present disclosure, a second step enhancement is utilized, which is most easily understood in the illustrated two-dimensional environment.

For example, in FIG. 1B, Corner 102a is associated with circle 130, Corner 102b is associated with circle 132, and Corner 102c is associated with circle 134. In step 218, unless the RSSI distance readings are dramatically in error, each two circle combination intersects one another at two points (or each two sphere combination intersects one another at a circle for the three-dimensional implementation). Thus, for circles 130, 132 the intersection points are 150, 152. For circles 132, 134, the intersection points are 154, 158. And for circles 130, 134, the intersection points are 156, 159. At step 220, the calculated coordinates of the endpoints of line segments 160, 162, 164 connecting the respective intersection points can be saved (or planes for the thee-dimensional implementation). With a minimum of three Corners, three such line segment values can be obtained. In an ideal situation, these three line segments (160, 162, 164) intersect one another at a single point (not shown). Most likely though they will intersect to form a smaller space 170, which in the illustrated two-dimensional embodiment, is in the geometric shape of a triangle (or volume in a three-dimensional implementation). The center of triangle 170 can be determined by repeating the process or through simple geometric calculations known to those skilled in the art. This enhanced position is the most probable current location of Target 104g.

Once the current location of Target 104g is determined, then at step 222, the software module does a check to see if that location is reasonable. For example, if Target 104g is in one location at one point in time and then one second later Target 104g is 100 m away (or three floors up), then there is something amiss and the calculation is discarded (step 224) and the process starts again. If, however, the current location seems reasonable, then the current location is deemed valid and utilized in some manner (e.g., sent to Target 104g), as indicated in step 226, or primary node 106 utilizes this positioning information in another suitable manner. For example, if Target 104g is in a large department store, a store-maintained database of known locations of articles of clothing may show that Target 104g is close to a counter of women’s casual shoes. If a buying history of a customer associated with Target 104g indicates a potential interest, then primary node 106 may send an advertisement to Target 104g via a text or suitable application associated with the customer’s smartphone (i.e., Target 104g). As another example, a user’s smartphone could show information about a museum exhibit that Target 104g just approached, or it could show if the user is walking in the right direction to get to the user’s next appointment in a building.

Compared to prior techniques, such as those described above, Constant Calculation does not require the intensive preparation of Thumb Printing, and is largely self-calibrating and self-correcting, and therefore is not as easily invalidated by environmental changes. In comparison to Proximity Sensing, it requires very minimal equipment. Constant Calculation also continuously computes the current position of the Targets 104 instead of simply knowing where a particular Target was last seen.

Although the subject system and method has been described with respect to some embodiments, it will be readily apparent to those having ordinary skill in the art to which it appertains that changes and modifications may be made thereto without departing from the spirit or scope of the subject apparatus.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of preferred embodiments. Those skilled in the art will envision other modifications within the scope and spirit of the claims appended hereto.

What is claimed is:

1. A method of determining a position of a target in an area of interest, comprising:
continuously scanning the area of interest using three secondary nodes;
detecting, via each secondary node, a received signal strength (RSSI) to the target;
determining a respective circle for each secondary node using the RSSI as the respective circle’s radius;
determining respective intersection points caused by an overlap between each two circle combination for each unique two secondary node combination of the three secondary nodes;
determining respective line segments for each set of respective intersection points; and
when intersections of the line segments creates a triangular space, determining a center of the triangular space, which is indicative of the position of the target.

2. The method of claim 1, wherein the secondary nodes and target are Bluetooth low energy (BLE) devices, and further comprising displaying the position of the target.

3. The method of claim 2, further comprising sending the position of the target to the target.

4. The method of claim 1, wherein the determining steps are performed by a primary node separate from the secondary nodes.

5. The method of claim 4, further comprising receiving, at the primary node, data from the secondary nodes, and determining a set of coordinates for the secondary nodes.

6. The method of claim 1, where continuously scanning includes scanning at intervals between one and five seconds.

7. A method of determining a position of a target in an area of interest, comprising:
continuously scanning the area of interest using four secondary nodes;
detecting, via each secondary node, a received signal strength (RSSI) to the target;
determining a respective sphere for each secondary node using the RSSI as the respective sphere’s radius;
determining respective intersection circles caused by an overlap between each two sphere combination for each unique two secondary node combination of the four secondary nodes;
determining respective planes for each set of respective intersection circles; and
when intersections of the planes creates a volumetric space, determining a center of the volumetric space, which is indicative of the position of the target.

8. The method of claim 7, wherein the secondary nodes and target are Bluetooth low energy (BLE) devices, and further comprising displaying the position of the target.

9. The method of claim 8, further comprising sending the position of the target to the target.

10. The method of claim 7, wherein the determining steps are performed by a primary node separate from the secondary nodes.

11. The method of claim 10, further comprising receiving, at the primary node, data from the secondary nodes, and determining a set of coordinates for the secondary nodes.

12. The method of claim 7, where continuously scanning includes scanning at intervals between one and five seconds.

13. A system for determining a position of a target in an area of interest, comprising:
at least three secondary nodes each configured to:
continuously scan the area of interest; and
detect a received signal strength (RSSI) to each other and to the target;
a primary node having a positioning module configured to:
determine a respective circle or sphere for each secondary node using the RSSI as the respective circle or sphere’s radius;
determine respective intersection points or circles caused by an overlap between each two-circle or two-sphere combination for each unique two primary node combination of the at least three primary nodes;
determine respective line segments or planes for each set of respective intersection points or circles; and
when intersections of the line segments or planes creates a respective triangular or volumetric space, determining a center of the respective triangular or volumetric space, which is indicative of the position of the target.

14. The system of claim 13, wherein the secondary nodes and target are Bluetooth low energy (BLE) devices, and wherein the positioning module is further configured to display the position of the target.

15. The system of claim 14, wherein the positioning module is further configured to send the position of the target to the target.
